(19) United States
(12) Patent Application Publication
(10) Pub. No.: US 2004/0006518 A1
(43) Pub. Date: Jan. 8, 2004

(54) Method of offering product information

(75) Inventors: Koichi Takahashi, Kawasaki (JP); Koji Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/291,416

(22) Filed: Nov. 12, 2002

(30) Foreign Application Priority Data
Jul. 3, 2002 (JP) 2002-194509

(51) Int. Cl. G06F 17/60

(52) U.S. Cl. 705/26

(57) ABSTRACT

A method of offering product information from a manufacturer server to a user server or to a shop server is provided. The manufacturer server receives usage record information including user ID information and product ID information and then stores it in a usage record information storage part. Product information is retrieved from the product information storage part using the received usage record information as a key. If the product information to be sent is sales promotion information, the time period of usage of the product is taken into consideration. Finally, the product information that may be promotion information and/or suggestion information is sent to the user server or to the shop server.

### BACKGROUND OF THE INVENTION

1. Field of the Invention

The present invention relates to a method of implementing an information-offering service via the Internet, and particularly relates to an information-offering service in which home electronics manufacturers offer product information to users and/or shops.

2. Description of the Related Art

Home electronics manufacturers offer product information using various methods of transmitting information. For example, in order to offer new product information, it is common to use commercials through the media such as television and radio broadcasts, advertisements in newspapers and magazines, direct mail, web sites and e-mail. Such methods are advantageous for widely spreading the product information, however, all of the above methods transmit standard information on an unsolicited basis and therefore are not useful in finding potential buyers.

A customer management system for obviating such a problem is known from JP-A-2001-23047, in which questionnaires completed by the user are used for creating sales promotion information that is customized for the user based on data such as attributes of the user, customer satisfaction ratings and purchase history.

However, the customer management system of JP-A-2001-23047 has drawbacks due to the fact that it is based on the results of the questionnaires completed by the user. Such a system is troublesome for the user and therefore there are cases where users do not sends back the questionnaires. Also, even for cases where the user actually send back the questionnaire, it is only possible to recognize the sending date of the questionnaire and it is not possible to recognize the actual time and date of starting the usage. Accordingly, such a system is not capable of meeting needs such as sending new product information when a predetermined period of time has elapsed from the usage start time.

Also, a method of offering useful product information to the user from the home electronics manufacturer is known from JP-A-2002-150115. JP-A2002-150115 discloses a method of offering information that provides via a network a smart mode of use related to the electronic appliance that is being used by the user.

The customer management system of JP-A2002-150115 is capable of sending information associated with the product that is being used by the user, but is not capable of sending information that is suitable for the manner in which the user uses the product. However, it does suggest substitute modes of use that the user may not be aware of. For example, it is not capable of suggesting a simpler mode of operation that could be used in place of the mode of operation normally used by the user.

### SUMMARY OF THE INVENTION

Accordingly, it is a general object of the present invention to provide an information-offering method that can obviate the problems described above.

It is another and more specific object of the present invention to provide a method of providing usage start time of the product to a manufacturer without requiring troublesome steps to be carried out by the users.

In order to achieve the above objects, a method of offering product information from a manufacturer server to a user server is provided, which includes the steps of:

a) receiving usage record information including user identification (ID) information and product identification (ID) information;

b) storing and accumulating the usage record information in a usage record information storage part;

c) determining whether a product specified by the product ID information has been used for a period longer than a predetermined period of time by referring to usage record information stored in a usage record information storage part that is associated with the product specified by the product ID information of a user specified by the user ID information;

d) retrieving sales promotion information associated with the product from a sales promotion information storage part in which sales promotion information is stored, when the result of the step c) is positive; and

e) sending the retrieved sales promotion information to the user server specified by the user ID information.

Further, a method of offering product information from a manufacturer server to a shop server is provided, which includes the steps of:

a) receiving usage record information including user identification (ID) information and product identification (ID) information;

b) storing and accumulating the usage record information in a usage record information storage part;

c) determining whether a product specified by the product ID information has been used for a period longer than a predetermined period of time by referring to usage record information stored in a usage record information storage part which is associated with the product specified by the product ID information of a user specified by the user ID information;

d) retrieving sales promotion information associated with the product from a sales promotion information storage part in which sales promotion information is stored, when the result of the step c) is positive; and

e) sending the retrieved sales promotion information and the user ID information to the shop server.

It is still another specific object of the present invention to provide a method of offering information that suits the mode of use of the user.

In order to achieve the object described above, a method of offering product information from a manufacturer server to a user server is provided, which includes the steps of:

a) receiving usage record information including user identification (ID) information and product identification (ID) information;

b) storing the usage record information in a usage record information storage part;

c) retrieving suggestion information that matches the user record information associated with a product specified by the product ID information of a user specified by the user ID information stored in the user record information storage part from a suggestion information storage part in which suggestion information is stored; and

d) sending the retrieved suggestion information to the user server specified by the user ID information.

Further, a method of offering product information from a manufacturer server to a shop server is provided, which includes the steps of:

a) receiving usage record information including user identification (ID) information and product identification (ID) information;

b) storing the usage record information in a usage record information storage part;

c) retrieving suggestion information that matches the user record information associated with a product specified by the product ID information of a user specified by the user ID information stored in the user record information storage part from a suggestion information storage part in which suggestion information is stored; and

d) sending the retrieved suggestion information and the user ID information to the shop server.

Thus, according to the invention described above, the manufacturer can acquire information representing precise time and date of a starting point of usage without requiring efforts being made by the users. Then, based on the acquired information, the manufacturer can offer sales promotion information to the user. The sales promotion information may be offered to the shop.

Further, information related to a usage mode that is suitable for the usage pattern of the user may also be offered to the user. This information may also be offered to the shop.

The present invention also relates to programs for causing a computer to perform the methods described above. The present invention further relates to a computer readable storage medium for storing program code for causing a computer to perform the method described above.

### BRIEF DESCRIPTION OF THE DRAWINGS

FIG. 1 is a configuration diagram of a system of a first embodiment of the present invention.

FIG. 2 is a schematic diagram showing a process performed according to the system of the first embodiment of the present invention.

FIG. 3 is a diagram showing a job flow of the system of the first embodiment of the present invention.

FIG. 4 is a diagram showing examples of usage record information, a user ID file and a manufacturer ID file.

FIG. 5 is a diagram showing an example of a usage record file.

FIG. 6 is a flowchart showing a process of editing sales promotion information and/or suggestion information.

FIG. 7 is a diagram showing examples of a product information file and a sales promotion information file.

FIG. 8 is a diagram showing examples of a suggestion information file and an e-mail message including sales promotion information and suggestion information.

FIG. 9 is a flowchart showing a process of sending sales promotion information and/or suggestion information.

FIG. 10 is a diagram showing examples of a transmission history information file and an e-mail message including suggestion information.

FIG. 11 is a configuration diagram of a system of a second embodiment of the present invention.

FIG. 12 is a schematic diagram showing a process performed according to the system of the second embodiment of the present invention.

FIG. 13 is a diagram showing job flow of the system of the second embodiment of the present invention.

FIG. 14 is a configuration diagram of a system of a third embodiment of the present invention.

FIG. 15 is a diagram showing job flow of the system of the third embodiment of the present invention.

FIG. 16 is a diagram showing an example of the usage record information.

### DETAILED DESCRIPTION OF THE PREFERRED EMBODIMENTS

In the following, principles and embodiments of the present invention will be described with reference to the accompanying drawings.

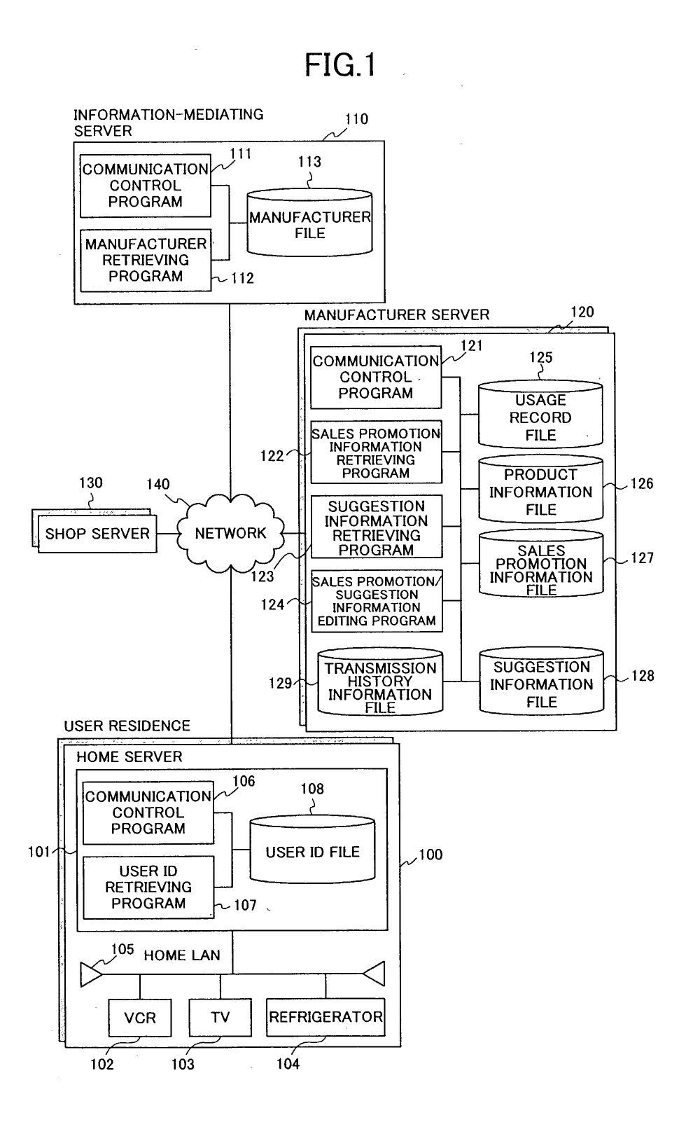

A general configuration of a system of a first embodiment of the present invention will be described with reference to FIG. 1.

In a user-residence 100, a home-LAN 105 is provided via which home electronic appliances, such as a home server 101, video cassette recorder (VCR) 102, a television (TV) 103 and refrigerator 104 are interconnected. The home-LAN 105 may be any a power line LAN or a wireless LAN, however, each home electronic appliance should have at least a function for sending its model name, serial number and operation attributes to the home server 101.

The home server 101 is a computer installed in the user residence 100 for mediating the home electronic appliances in the user residence 100 and an external network external to the user residence 100.

The home server 101 includes a communication control program 106 for communications between each of the home electronic appliances and the external network and a user identification (ID) retrieving program 107 for generating data to be sent on the external network.

These programs are stored in an external storage device (not shown) connected to the home server 101 and are loaded into an internal storage device during execution of each program.

Further, the external storage device connected to the home server 101 stores a user identification (ID) file 108 in which information for identifying the user is stored. The user ID file 108 is referred to or updated by the communication control program 106 or by the user ID retrieving program 107 as required.

An information-mediating server 110 is a computer for mediating information from the home server 101. The information-mediating server 110 distributes information to corresponding manufacturers.

The information mediating server 110 includes a communication control program 111 for controlling communications between the home server 101 and each manufacturer and a manufacturer retrieving program 112 for controlling where the information from the home server 101 is to be distributed.

These programs are stored in an external storage device (not shown) connected to the information mediating server 110 and are loaded into an internal storage device during execution of each program.

Further, the external storage device connected to the information mediating server 110 stores a manufacturer file 113 in which server names of manufacturers are stored. The manufacturer file 113 is referred to or updated by the communication control program 111 and by the manufacture retrieving program 112 as required.

A manufacturer server 120 is a computer installed at the manufacturer of home electric appliances that provides product information to the home server 100 or to a shop server 130 based on information obtained from the external network.

The manufacturer server 120 includes a communication control program 121 for communications with an external network, a sales promotion information retrieving program 122 for retrieving sales promotion information, a suggestion information retrieving program 123 for retrieving suggestion information and sales promotion/suggestion information editing program 124 for editing sales promotion/suggestion information.

These programs are stored in an external storage device (not shown) connected to the manufacturer server 120 and are loaded into an internal storage device during execution of each program.

Further, the external storage device of the manufacturer server 120 stores a usage record file 125 in which usage records of the users are accumulated, a product information file 126 in which product information is stored, a sales promotion information file 127 in which sales promotion information is stored, a suggestion information file 128 in which suggestion information is stored and a transmission history file 129 in which a history of offering the product information is stored. These files are referred to or updated by the communication control program 121, by the sales promotion retrieving program 122, by the suggestion information retrieving program 123 and by the sales/suggestion information editing program 124 as required.

The shop server 130 is installed at retail shops that sell home electric appliances and/or a head office of a vendor company. The shop server receives the product information from the manufacturer server and offers the information to shop assistants and the users.

The above-mentioned home server 101, the information mediating server 110, the manufacturer server 120 and the shop server 130 are interconnected via the network 140. The network 140 may be the Internet or a public line as long as information can be electronically communicated via the network 140.

It is to be noted that in the following description, similar numerals are used for indicating corresponding elements that have been described above.

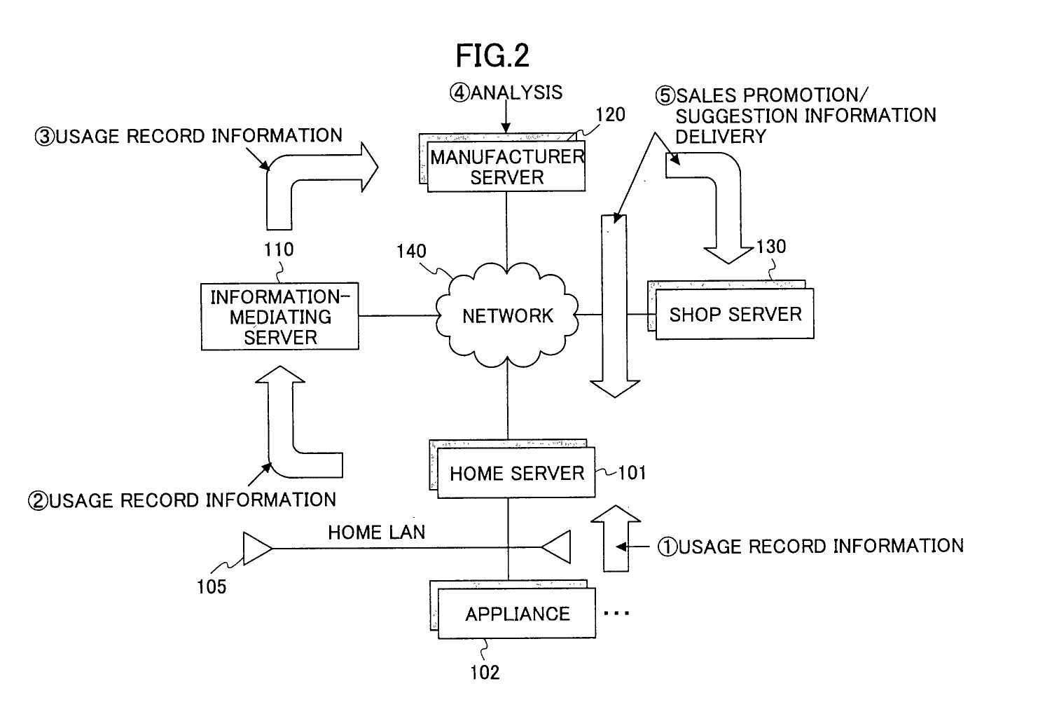

A process performed according to the system of the first embodiment of the present invention will be described with reference to FIG. 2.

The home server 101, the information-mediating server 110, the manufacturer server 120 and the shop server 130 are interconnected via the network 140. The appliance 102 represents one of the home electric appliances such as the VCR 102, the TV 103 and the refrigerator 104 illustrated in FIG. 1. When there is an operation performed on the appliance 102, such as switching the power ON and submitting a replay command, the usage record information associated with the operation is sent to the home server 101 via the home LAN 105. The home server 101 adds the user ID information to the usage record information and sends it to the information-mediating server 110. The description has been made for a case where it is performed each time the usage record information is received from the appliance 102, however, it is also possible to accumulate the usage record information and perform batch processes at a regular interval.

The information-mediating server 110 determines the relevant manufacturer from the usage record information received from the home server 101 and transfers it to the manufacturer server 120 of the relevant manufacturer. Even if it is difficult to maintain information related to all manufacturers of each appliance on the home server 101, with the information-mediating server 110 taking control of such information, the information will be automatically sent to the corresponding manufacturer server of the manufacture. For this automatic sending operation, the home server 101 only needs to send the manufacturer name and the product model name.

The manufacturer server 120 analyses the usage record information received from the information-mediating server 110 and sends the sales promotion/suggestion information to the home server 101 or to the sales server 103 as required. The product information not only may be sent directly to the home server 101 but also may be sent to the shop server 130 in order to prevent distributors from being excluded from the distributive trades as a result of the manufacturers and the users being directly linked to each other. The retailers are now capable of making approaches to the users using the product information.

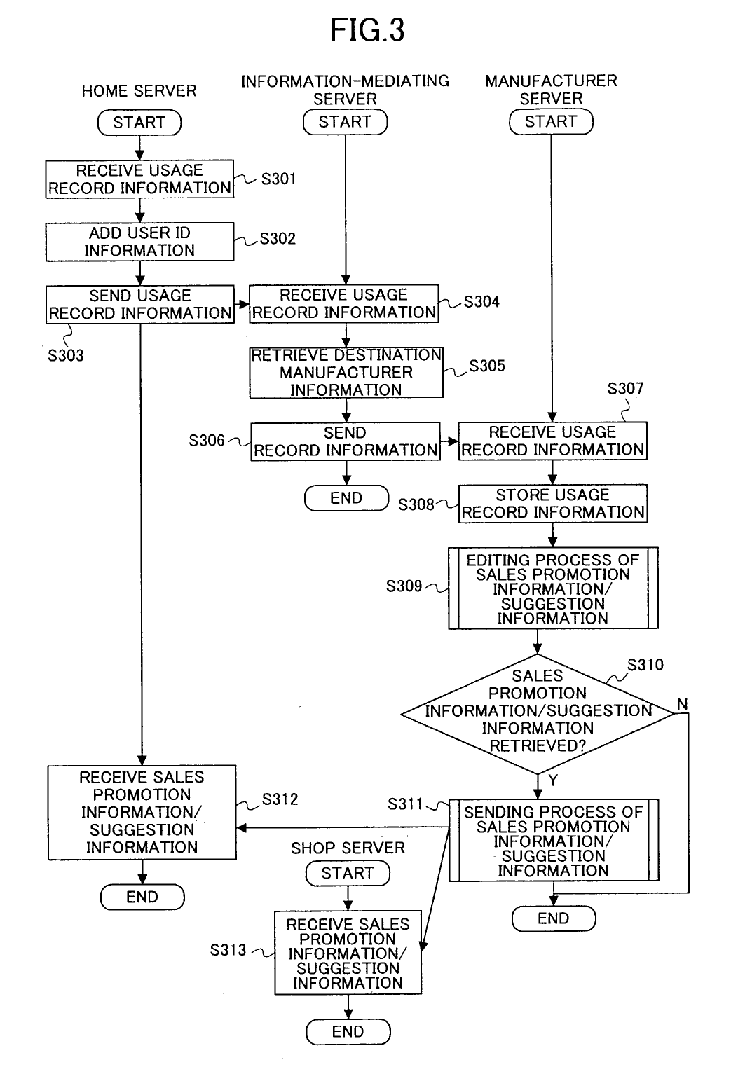

A job flow of the system of the first embodiment of the present invention will be described with reference to FIG. 3.

When a certain operation is made at the appliance 102, usage record information is transmitted to the home server 101 via the home LAN 105. The communication control program 106 in the home server 101 receives the usage record information (S301).

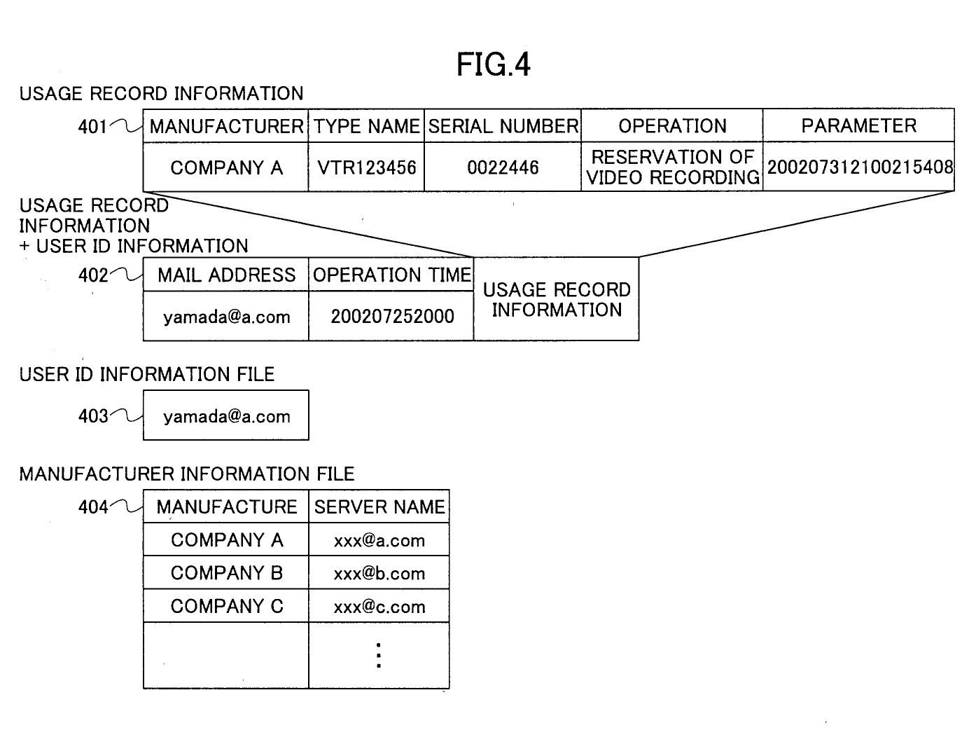

Referring now to FIG. 4, an example of a format of the usage record information 401 received by the communication control program 106 will be described. The usage record information 401 includes a MANUFACTURER field for name of the manufacture, a MODEL NAME field for model name of the appliance, a SERIAL NUMBER field for the serial number of the appliance, an OPERATION field for attributes of operation performed by the user and a PARAMETER field for a parameter that can arbitrary set for the relevant operation. The usage record information 401 of the illustrated example relates to a product “VTR123456” manufactured by “COMPANY A” with the serial number “0022446”. For the sake of convenience of explanation, it is assumed that the product is a video cassette recorder. It is also assumed that the operation performed by the user is reservation of video recording and that information related to reservation of video recording is set in the PARAMETER field. The information “200207312100215408” represents that video recording operation is reserved for channel 8 on Jul. 31, 2002, from 21:00 to 21:54.

After reception of the usage record information by the communication control program 106, the user ID retrieving program 107 of the home server 101 retrieves the user identification (ID) information from the user identification (ID) file 108 and adds the user ID information to the usage record information (S302).

The user ID information is stored in the user ID file 108. For example, information identifying the user may be an electronic mail (email) address stored as shown by a user ID information file 403 of FIG. 4.

The user record information+user ID information 402 of FIG. 4 is an example of the usage record information with the user ID information being added thereto. The user record information+user ID information 402 includes the usage record information 401 and the user ID information of the user ID information file being added thereto. In this example, the user ID information is an e-mail address and, therefore, the item of the user record information+user ID information 402 is “MAIL ADDRESS” instead of “user ID information”. Also, operation time is added which indicates the time at which the user performed the operation. If a precise operation time is required, it is also possible to add information about the operation time upon transmission of the usage record information from the appliance 102.

Then, the communication control program 106 sends the usage record information accompanied by the user ID information to the information-mediating server 110 (S303). The communication control program 111 of the information-mediating server 110 receives the usage record information sent from the home server 101 (S304).

The manufacturer retrieving server 112 of the information-mediating server 110 performs a search on the manufacturer file 113 with the search key being the information included in the MANUFACTURER field of the usage record information received in S304. A manufacturer information file 404 shown in FIG. 4 is an example of the manufacturer file 113. The manufacturer information file 404 has a MANUFACTURER field for name of the manufacturer and a SERVER NAME field for name server of the corresponding manufacturer. In the present embodiment, since the MANUFACTURER field of the usage record information includes “COMPANY A”, a search is performed on the manufacturer information file 404 using “COMPANY A” as a search key and the search result is the SERVER NAME “xxx.a.com”.

In the present embodiment, the name of manufacturer is set in the usage record information and the server name is searched for using the manufacturer name as a search key. However, it is also possible to select the MODEL NAME field, instead of the MANUFACTURER field, as a key item of the manufacturer file 113. In such a case, there is no need to set MANUFACTURER in the usage record information.

After the server name of the destination manufacturer being specified in step S305, the communication control program 111 of the information-mediating server 110 sends the usage record in formation to the manufacturer server 120 (S306). The communication control program 121 of the manufacturer server 120 receives the usage record information sent from the information-mediating server 110 in step S306 (S307).

The manufacturer server 120 stores the usage record information received in step S307 in the usage record file 125.

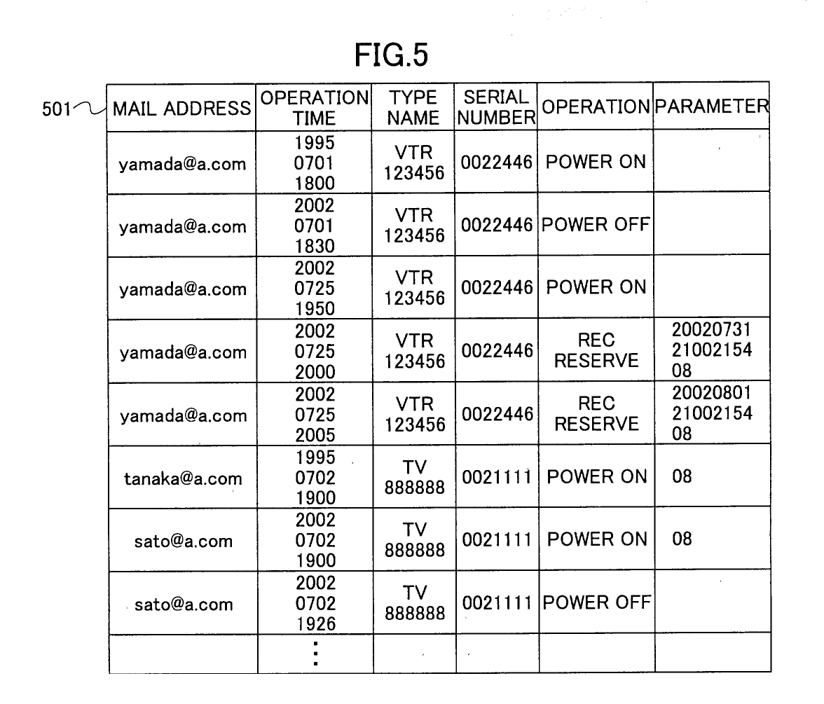

Referring to FIG. 5, an example of the usage record file 125 is illustrated with a reference numeral 501. The usage record file 125 includes a MAIL ADDRESS field which is an identification (ID) information of the user, an OPERATION TIME field for an operation time of the user, a MODEL NAME field for a model name of the appliance, a SERIAL NUMBER field for serial number of the appliance, an OPERATION field for attribute of operation performed by the user and a PARAMETER field for a parameter that can arbitrary set for the relevant operation. The usage record file 125 stores and accumulates the usage record information received by the manufacturer server 120.

After storing the usage record information in step S308, an editing process of the sales promotion information and suggestion information is performed based on the usage record information that is a user data specified by this usage record information and that is related to the appliance specified by this usage record information (S309).

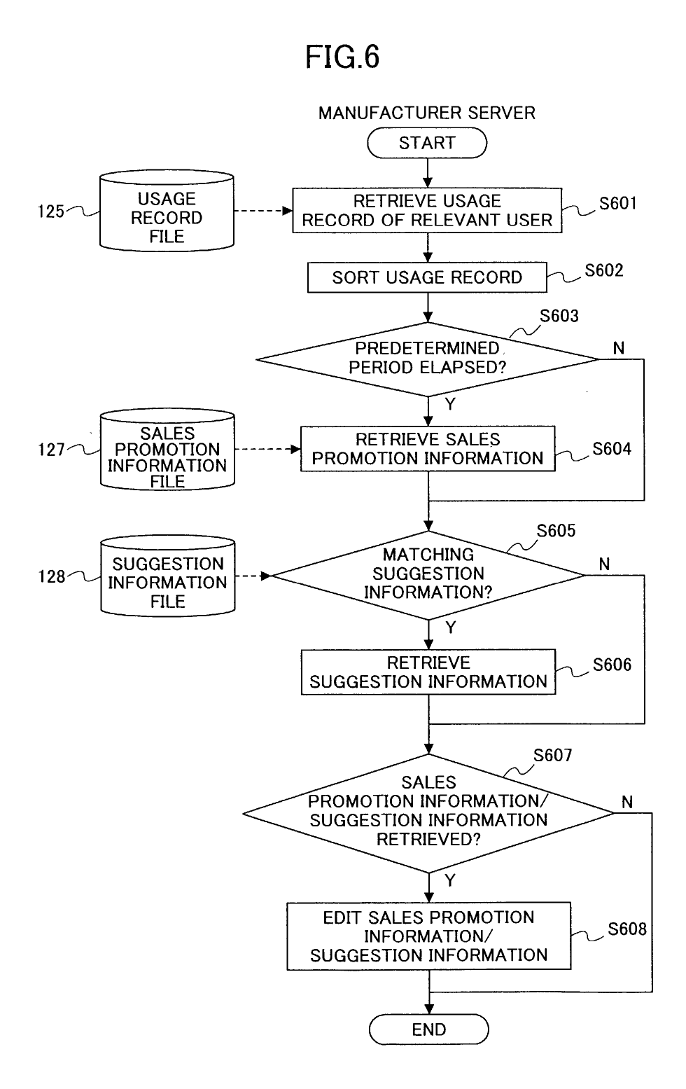

Referring to FIG. 6, the editing process of the sales promotion information/suggestion information will be described in detail.

The sales promotion information/suggestion information editing program 124 retrieves from the usage record file 125 the data related to the user specified by the received usage record information and that is also data of an appliance specified by the received usage record information (S601). Then, the retrieved usage record data is sorted using the OPERATION TIME as a sort key (S602).

Then, it is determined whether the appliance has been used for a certain period of time (S603). The earliest data can be identified from the OPERATION TIME after sorting operation of step S602. The determination is performed by comparing the OPERATION TIME and the current time with a certain period of time that has been determined in advance. In the prior art method, questionnaires are used to collect information. With such questionnaires, it is only possible to obtain data as to whether the product has been purchased or not. However, according to the determining step of the present invention, it is possible to obtain the actual usage start date and therefore a usage period can be determined more precisely.

In the present embodiment, the OPERATION TIME of in the data stored in the usage record file is set to time and date of the processing at the home server 101. However, it is also possible to set the OPERATION TIME at the appliance 102 to know a more precise operation time. In a case where such precise information is not necessary and it is desired to reduce time taken for transmitting and receiving data, it can be the manufacturer server 120 that sets the time and date of reception.

Also, in the present embodiment, the process is performed using data of the same appliance of the same user. However, for example, for MODEL NAME “TV888888” and SERIAL NUMBER “0021111”, there are usage records for two users, i.e., “tanaka@a.com” and “sato@a.com”. This indicates that “tanaka@a.com” was first using the appliance, and subsequently “sato@a.com” took over the usage of the appliance. In such a case, with the present embodiment of the present invention, it is determined that the appliance has not been used for a predetermined period of time since the determination is made based on the date when “sato@a.com” first started using the appliance. However, in order to know the actual usage time period, the starting date of the usage of the appliance should be dated back to the date when “tanaka@a.com” started using the appliance.

Taking this into consideration, the search of the usage record file 501 may be performed using the MODEL NAME and the SERIAL NUMBER so as to perform the determination step of S603 using the OPERATION TIME of the earliest data obtained from such a search operation. Thus, since the search operation of the usage record file 501 is performed using MODEL NAME “TV888888” and SERIAL NUMBER “0021111” when performing a process for “sato@a.com”, a record of “tanaka@a.com” can be obtained. Thereby, the actual usage start date, i.e., Jul. 2, 1995 in this case, can be obtained.

If the result of the determination step of S603 indicates that the appliance has been used for a time period that exceeds a predetermined period of time, the sales promotion information retrieving program 122 performs a search on the sales promotion information file 127 and retrieves the sales promotion information (S604). If the result of the determination step of S603 indicates that the appliance has not been used for a predetermined period of time, the process proceeds to step S605.

The retrieving step of S604 aims for obtaining sales promotion information related to the product type whereto the relevant product belongs using the MODEL NAME of the usage record information. First, the sales promotion information retrieving program 122 performs a search on the product information file 126 using MODEL NAME as the key.

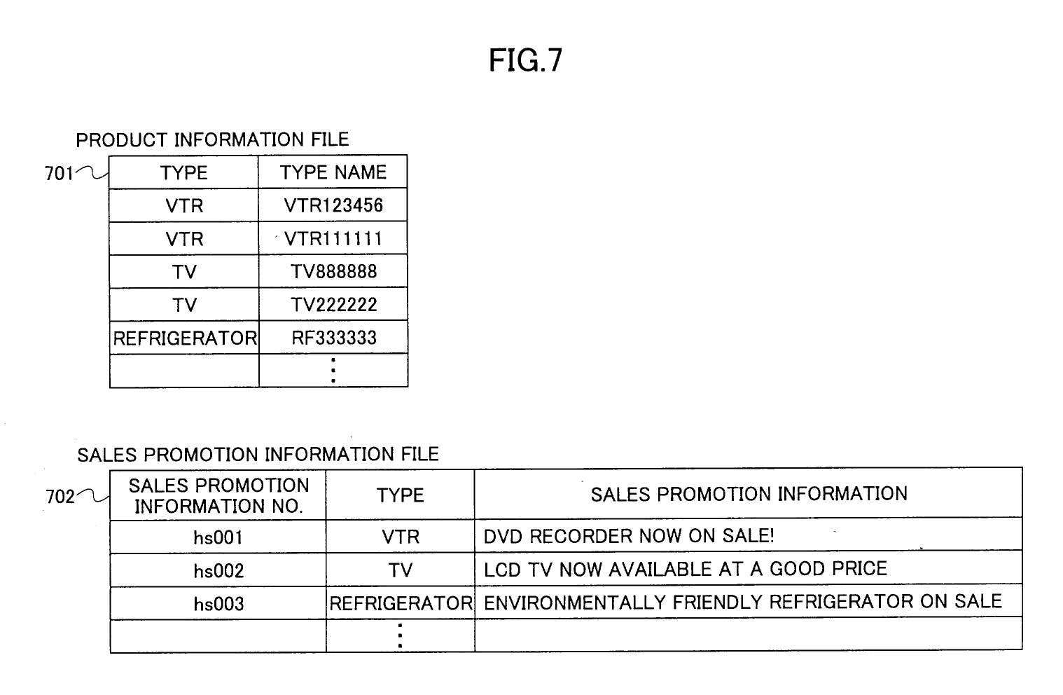

An example of the product information file is shown in FIG. 7 as a product information file 701. The product information file 701 includes a TYPE field for product type whereto the appliance belongs and a MODEL NAME field for model name of the appliance. In the present embodiment, a search is performed using “TVR123456” as a key. Therefore, the search result of the product information file 701 indicates that the product type is a video cassette recorder (VCR).

Then, the sales promotion information retrieving program 122 performs a search on the sales promotion information file 127 to obtain the sales promotion information related to the video cassette recorder.

An example of the sales promotion information file 127 is shown in FIG. 7 as a sales promotion information file 702. Sales promotion information for each of the appliance product types is stored in the sales promotion information file 702. The sales promotion information file 702 includes SALES PROMOTION INFORMATION NO field for sales promotion information number that uniquely identifies the record, a TYPE field for appliance product type and a SALES PROMOTION INFORMATION field for sales promotion information. In the present embodiment, since a search is performed using the video cassette recorder as a search key, the sales promotion information “DVD RECORDER NOW ON SALE!” can be obtained. Then, the record corresponding to the sales promotion number “hs001” is retrieved.

Then, suggestion information is retrieved based on the usage record information. In order to search for the suggestion information that is suitable for the mode of use by the corresponding user, the history of usage record of the corresponding user is searched for in the suggestion information file 128.

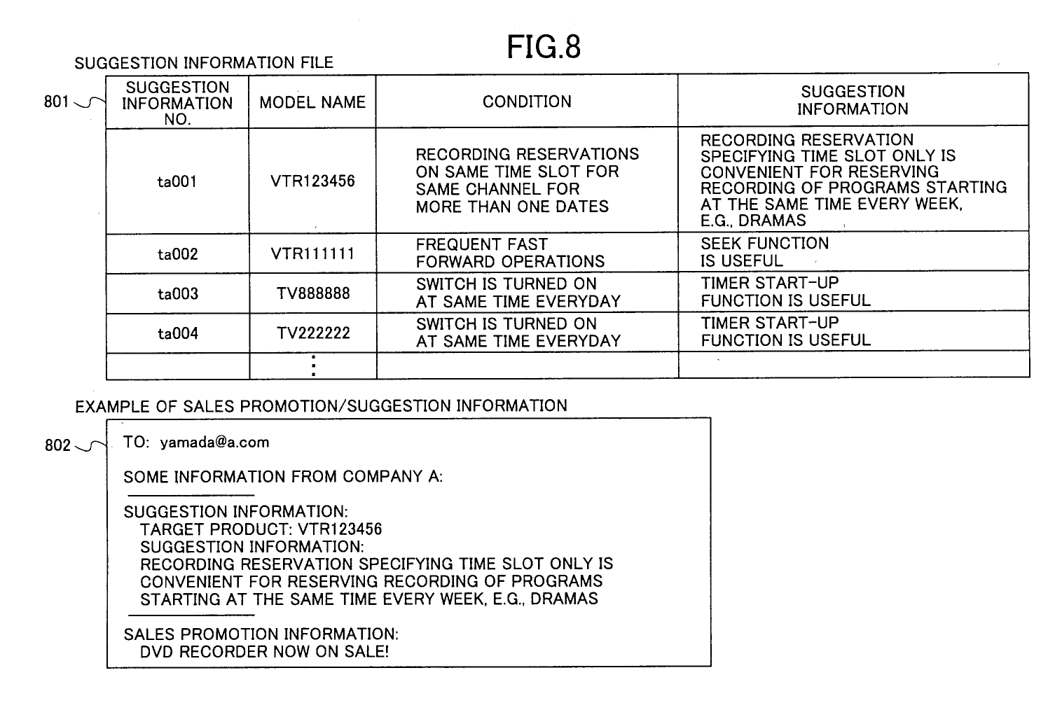

An example of the suggestion information file 128 is shown in FIG. 8 as a suggestion information file 801. The suggestion information file 801 includes a SUGGESTION INFORMATION NO for a suggestion information number that uniquely identifies the record, a TYPE field for appliance product type, a CONDITION field indicating combinations of operation attributes and a SUGGESTION INFORMATION field for suggestion information. Then reference is made to the operation history of the user and to the parameter to determine whether an operation that matches the condition has been performed (S605).

If the result of the determination step of S605 indicates that there is matching suggestion information, the suggestion information retrieving program 123 retrieves the suggestion information by performing a search on the suggestion information file 128 (S606). If the result of the determination step of S605 indicates that there is no matching suggestion information, the process proceeds to step S607.

In the present embodiment, referring to the operation and the parameter of the fourth and fifth records of the usage record file 501, it can be seen that the reservations of video recording are made for the time slot between 21:00 to 21:45 for channel 8 for different dates. This matches the condition “RECORDING RESERVATIONS ON SAME TIME SLOT FOR SAME CHANNEL FOR MORE THAN ONE DATES” for suggestion information number “ta001” of the suggestion information file 801. Accordingly, the suggestion information “RECORDING RESERVATION SPECIFYING TIME SLOT ONLY IS CONVENIENT FOR RESERVING RECORDING OF PROGRAMS STARTING AT THE SAME TIME EVERY WEEK, E.G., DRAMAS” can be obtained. Then, the record for suggestion information number “ta001” is retrieved.

Then, it is determined whether the sales promotion information or the suggestion information has been retrieved at steps S604 and S606 (S607). If the result of step S607 indicates that the sales promotion information or the suggestion information has been retrieved, the sales promotion/suggestion information editing program 124 edits the sales promotion information/suggestion information to be offered to the user or to the shop based on the sales promotion information and/or suggestion information retrieved at steps S604 and S606 (S608). If the result of step S607 indicates that neither the sales promotion information nor the suggestion information has been retrieved, the editing process (S309) of the sales promotion information/suggestion information is terminated.

Reference numeral 802 of FIG. 8 indicates an example of a format for sending the sales promotion information/suggestion information. The suggestion information and the sales promotion information are indicated together. In other words, this e-mail message is edited by pasting the information retrieved in steps S604 and S606 into the e-mail message.

Referring back to FIG. 3, the sales promotion/suggestion information editing program determines in step S310 whether the sales promotion information and the suggestion information have been retrieved in the sales promotion information/suggestion information editing process of S309.

If the result of the determination step of S310 indicates that the sales promotion information/suggestion information has been retrieved, the sales promotion information/suggestion information is transmitted (S311). If the result of the determination step of S310 indicates that the sales promotion information/suggestion information has not been retrieved, the process is terminated.

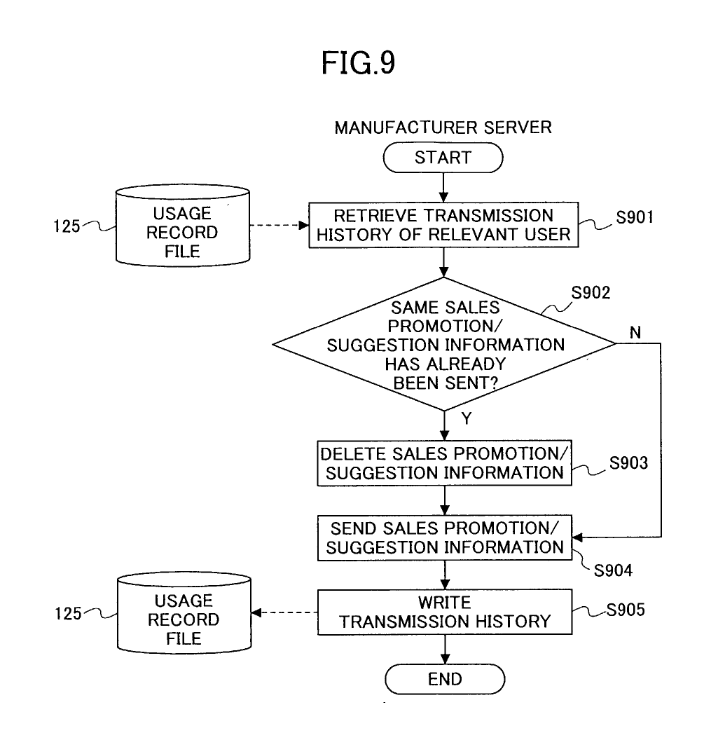

The transmission process of sales promotion information/suggestion information will be described in detail with reference to FIG. 9.

In this step, the product information such as the sales promotion information/suggestion information is sent to the user. However, it should be avoided to repeatedly send the same product information to the user since the user may get annoyed. Therefore, it is an object of this process to control the sending of the product information such that the same product information will not be repeatedly sent to the user.

First, a reference is made on the past transmission history to retrieve transmission history of the relevant user (S901). In the present embodiment, the sales promotion information number hs001 and the suggestion information number ta001 are retrieved in step S901, and therefore, these numbers are used as a search key for performing a search on the transmission history information file 129.

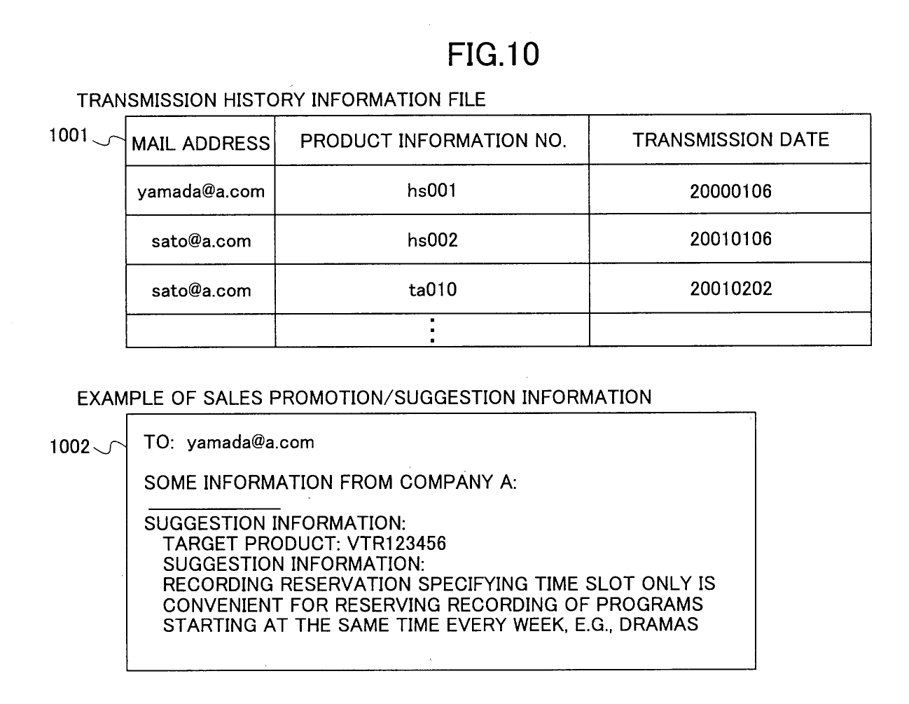

A transmission history information file 1001 of FIG. 10 is an example of the transmission history information file 129. The transmission history information file 1001 is a file in which the history of the product information sent in the past is stored. The transmission history information file 1001 includes a MAIL ADDRESS field for e-mail addresses identifying the users, a PRODUCT INFORMATION NO. field for identifying product information sent in the past and a TRANSMISSION DATE field for date of transmission of the product information.

Then, it is determined whether the same sales promotion/suggestion information (product information) has already been transmitted (S902). If the result of the determination step of S902 indicates that the same product information has already been sent, the already sent product information is deleted from the e-mail edited in step S608 (S903). If the result of the determination step of S902 indicates that the same product information has not been sent, there is no need to perform a delete operation, and the process proceeds to step S904.

In the present embodiment, a search is performed to determine whether there is a history indicating that the product information numbers hs001 and ta001 have been sent in the past to yamada@a.com. As a result of a search on the transmission history information file 1001, it can be seen that the information of hs001 has already been sent in the past. Accordingly, only the sales promotion information corresponding to hs001 is deleted from the e-mail edited in step S608. An example of such an e-mail message is illustrated in FIG. 10 as a sales promotion/suggestion information example 1002. In this manner, the sales promotion information is deleted from the e-mail message and only the suggestion information remains in the e-mail message.

Then, the communication control program 121 sends the edited e-mail message to the home server 101 or to the shop server 130 (S904). Also, in the present embodiment, the product information is transmitted as an e-mail message, but it may be transmitted in any form of transmission such as a telegraph message. Then, the current transmission record is stored in the transmission history file 125 to save it in the history (S905).

The communication control program 106 of the home server 101 receives this e-mail message (S312). Also, the shop server 130 receives this e-mail message (S313).

In this manner, appropriate product information based on the operation record of the user is sent to the home server or to the shop server.

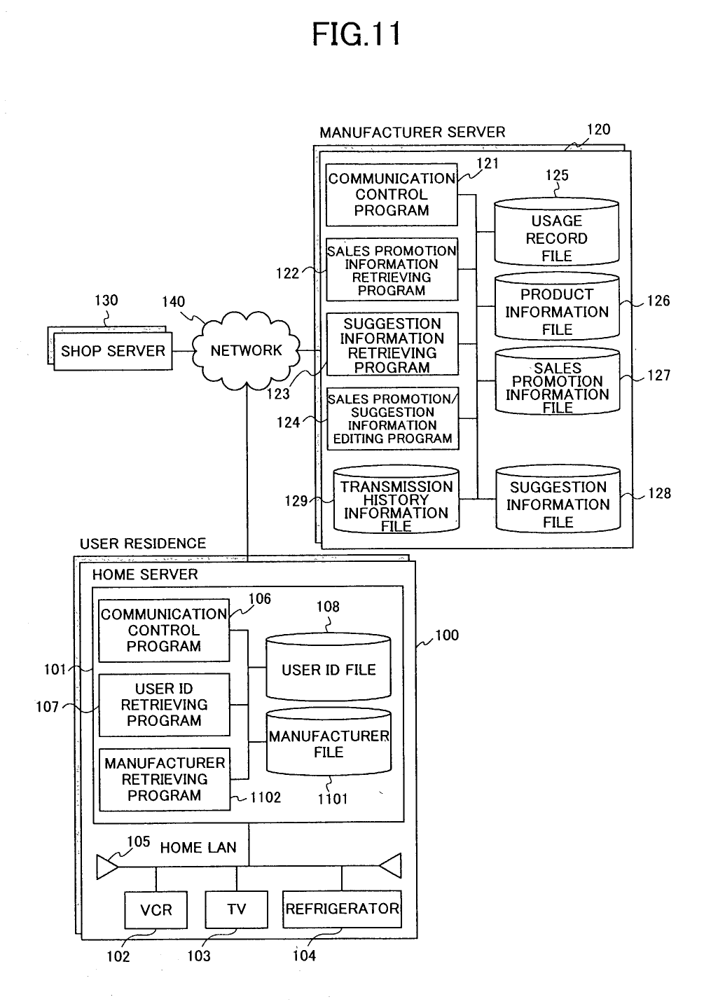

A system configuration according to the second embodiment of the present invention will be described with reference to FIG. 11.

In the first embodiment, the information-mediating server 110 mediates between the home server 101 and the manufacturer server 120, whereas, in the second embodiment, the usage record information is directly sent without being mediated by the information-mediating server 110. In other words, the information-mediating sever 110 is not used in the present embodiment. The manufacturer file 1101 and the manufacturer retrieving program 1102 are provided in the home server 101.

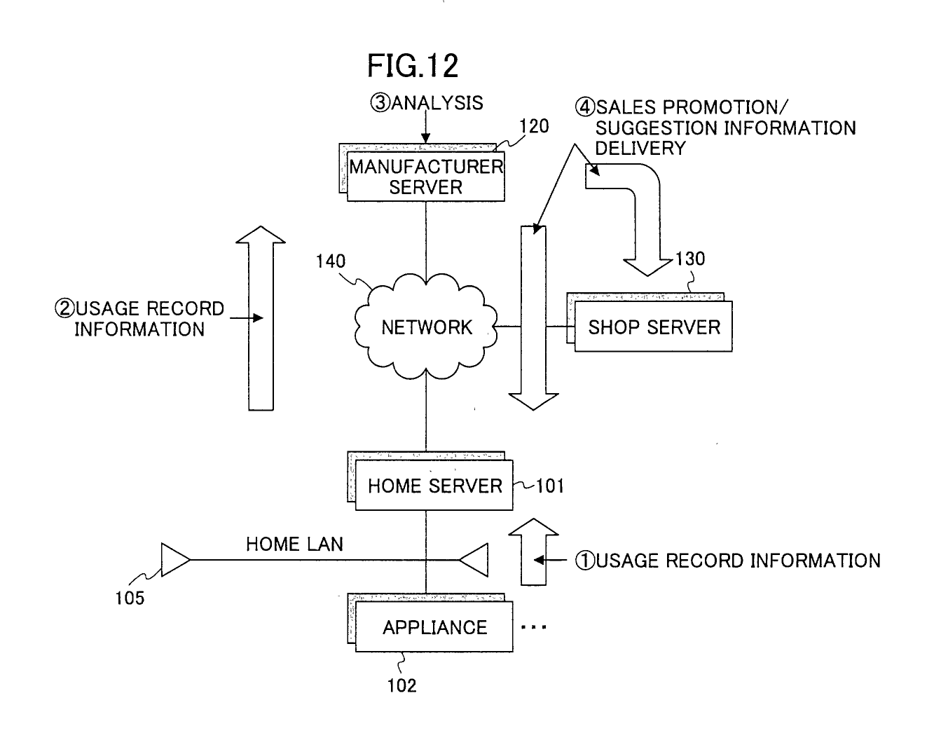

A process performed according to the system of the second embodiment of the present invention will be described with reference to FIG. 12. Since the destination of the usage record information is determined in the home server 101, the difference with the first embodiment is that the usage record information is directly sent to the manufacturer server 120.

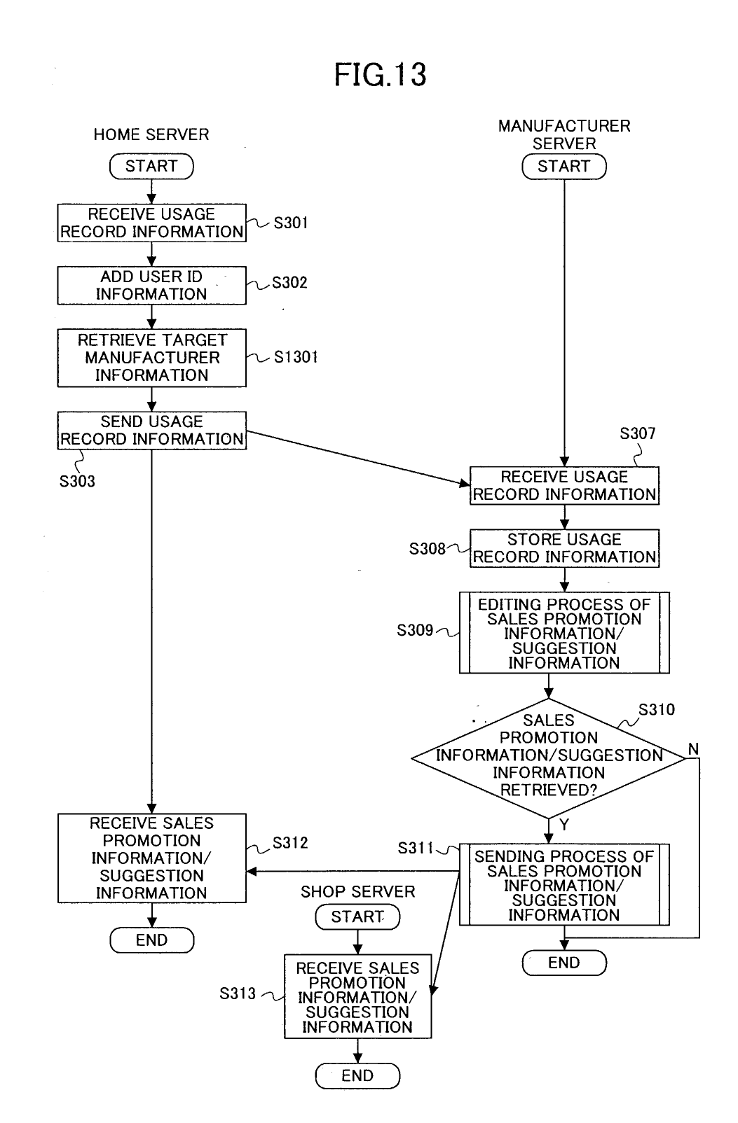

A job flow of the system of the second embodiment of the present invention will be described with reference to FIG. 13. The communication control program 106 of the home server 101 receives the usage record information (S301) and adds the user TD information to the usage record information (S302). Then the manufacturer retrieving program 1102 performs a search on the manufacturer file 1101 using the usage record information received at step S301 as a search key. The manufacturer file 1101 in the present embodiment is the same as the manufacture information file 404 shown in FIG. 4. Since the manufacturer of the usage record information is company A, a search is performed on the manufacturer file 1101 using company A as a search key and the server name “xxx.a.com” is obtained.

After the server name of the destination manufacturer is specified in step S1301, the communication control program 106 sends the usage record information to the manufacturer server 120 (S303). The following processes in the flow are the same as in the first embodiment of the present invention, and therefore a detailed description will be not be made.

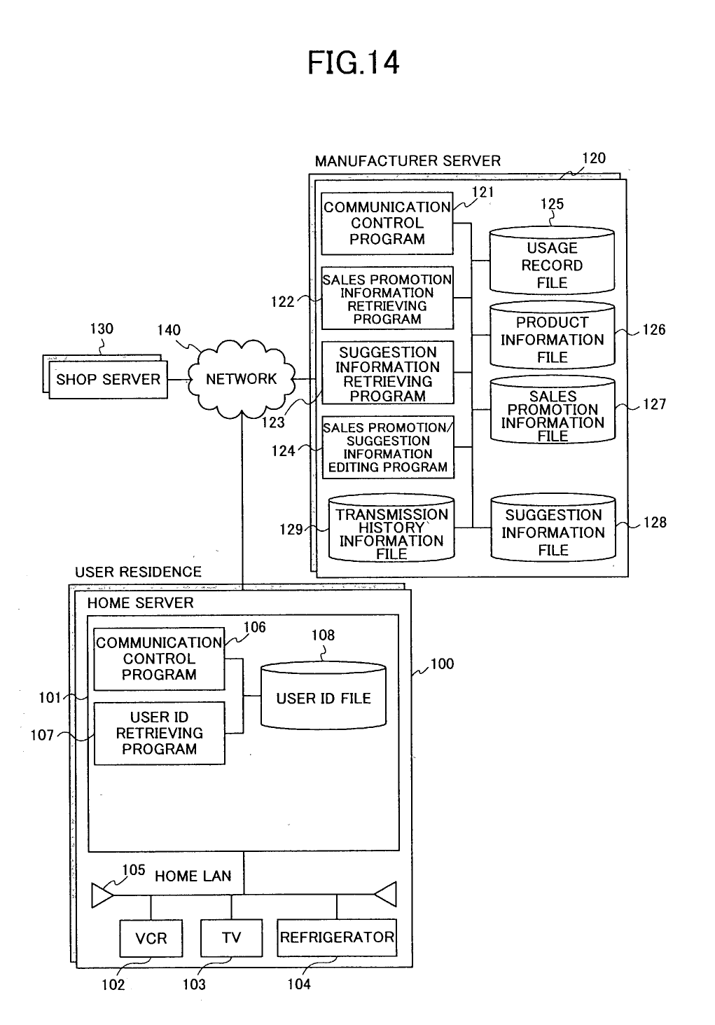

A system configuration according to the third embodiment of the present invention will be described with reference to FIG. 14.

In the second embodiment, the manufacturer file 1101 is provided in the home server 101 and the destination of the manufacturer is determined based on the information in the manufacturer file 1101. Whereas in the third embodiment, the server name is received from each appliance without using the manufacturer file 1101. Therefore, in the present invention, neither the manufacturer file 1101 nor the manufacturer retrieving program 110 is provided in the home server 101.

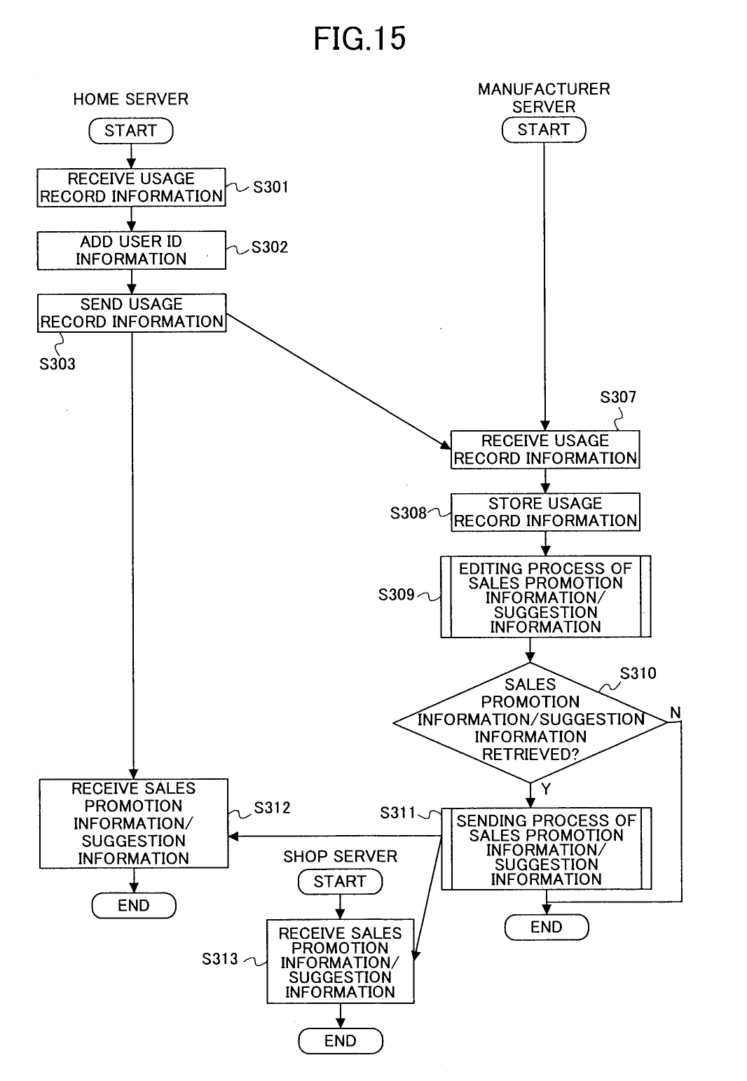

A job flow of the system of the third embodiment of the present invention will be described with reference to FIG. 15.

When there is a certain operation performed on the appliance 102, the usage record information is sent to the home server 101 via the home LAN 105. The communication control program 106 of the home server 101 receives the usage record information (S301).

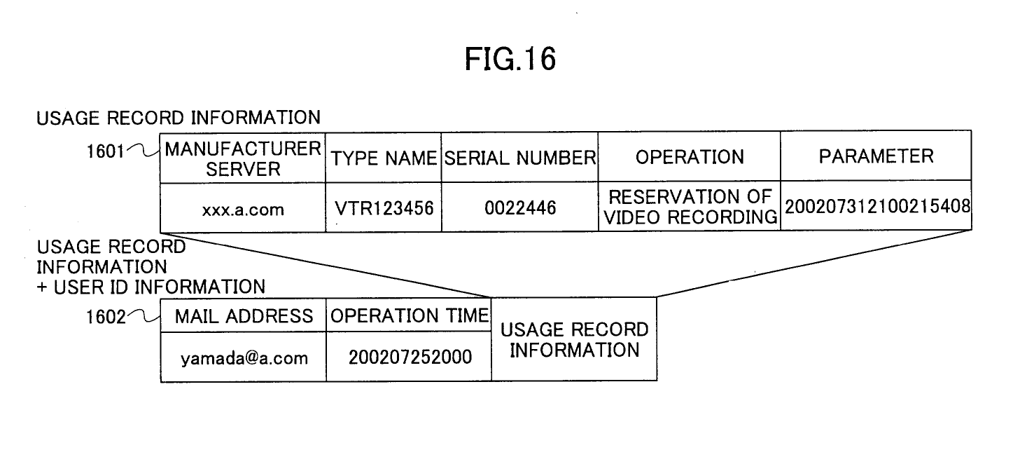

Referring now to FIG. 16, an example of a format of the usage record information received by the communication control program 106 will be described. The usage record information 1601 includes a MANUFACTURER field for name of the manufacturer, a MODEL NAME field for the model name of the appliance, a SERIAL NUMBER field for the serial number of the appliance, an OPERATION field for an attribute of operation performed by the user and a PARAMETER field for a parameter that can be arbitrary set for the relevant operation. In the example of usage record information 1601, it can be seen that the destination of usage record information is “xxx.a.com”.

Then, the user ID retrieving program 107 adds the user ID information stored in the user ID file 108 to the usage record information (S302). The usage record information+user ID information 1602 shown in FIG. 16 is an example of the usage record information with the user ID information being added thereto. The user record information+user ID information 1602 includes the usage record information and the user ID information of the user ID information file added thereto.

Then, the communication control program 106 sends the usage record information accompanied by the user ID information to the manufacturer server 120 (S303). The remaining steps are similar to those of the second embodiment and will not be described in detail.

Also, it is to be noted that the processes of the present invention can be stored on a computer readable storage medium as a program for operating the computer. The present invention can be implemented by performing the program on the computer. The computer readable storage medium may be any medium such as a magnetic storage device and a solid-state memory. For distribution in the market, the program can be stored on a portable storage medium such as CD-ROM (Compact Disk Read Only Memory) and a floppy disk (registered trade mark) or can be transferred to other computers via a network.

In the embodiment described above, the home server 101 is provided in the user residence 100. However, the information can be directly transmitted from each appliance to the manufacturer server instead of being transmitted via the home server 101.

Also, in the embodiment described above, the information sent to the manufacturer server 120 is described as an e-mail address which is the minimum information required to specify the user. However, it is also possible to send information such as street address and name of the user used for sending direct mail (DM).

Further, the present invention is not limited to these embodiments, and variations and modifications may be made without departing from the scope of the present invention.

The present application is based on Japanese priority application No. 2002-194509 filed on Jul. 3, 2002, the entire contents of which are hereby incorporated by reference.

What is claimed is:

1. A method of offering product information from a manufacturer server to a user server, said method comprising the steps of:
a) receiving usage record information including user identification (ID) information and product identification (ID) information;
b) storing and accumulating said usage record information in a usage record information storage part;
c) determining whether a product specified by said product ID information has been used for a period longer than a predetermined period of time by referring to said usage record information stored in said usage record information storage part which is associated with said product specified by said product ID information of a user specified by said user ID information;
d) retrieving sales promotion information associated with said product from a sales promotion information storage part in which sales promotion information is stored, when the result of said step c) is positive; and
e) sending said retrieved sales promotion information to the user server specified by said user ID information.

2. The method as claimed in claim 1, wherein said step e) is performed only when said retrieved sales promotion information has not been sent in the past.

3. The method as claimed in claim 1, wherein said step c) is performed by comparing time and date of the earliest record of the usage record information stored in said usage record information storage part which is specified by said usage ID information and said product ID information with time and date of processing.

4. A method of offering product information from a manufacturer server to a shop server, said method comprising the steps of:
a) receiving usage record information including user identification (ID) information and product identification (ID) information;
b) storing and accumulating said usage record information in a usage record information storage part;
c) determining whether a product specified by said product ID information has been used for a period longer than a predetermined period of time by referring to said usage record information stored in said usage record information storage part which is associated with said product specified by said product ID information of a user specified by said user ID information;
d) retrieving sales promotion information associated with said product from a sales promotion information storage part in which sales promotion information is stored, when the result of said step c) is positive; and
e) sending said retrieved sales promotion information and said user ID information to the shop server.

5. The method as claimed in claim 4, wherein said step e) is performed only when said retrieved sales promotion information has not been sent in the past.

6. The method as claimed in claim 4, wherein said step c) is performed by comparing time and date of the earliest record of the usage record information stored in said usage record information storage part which is specified by said usage ID information and said product ID information with time and date of processing.

7. A method of offering product information from a manufacturer server to a user server, said method comprising the steps of:
a) receiving usage record information including user identification (ID) information and product identification (ID) information;
b) storing said usage record information in a usage record information storage part;
c) retrieving suggestion information that matches the user record information associated with a product specified by said product ID information of a user specified by said user ID information stored in said usage record information storage part from a suggestion information storage part in which suggestion information is stored; and
d) sending said retrieved suggestion information to the user server specified by said user ID information.

8. The method as claimed in claim 7, wherein said suggestion information storage part stores a combination of a plurality of operation attribute information and suggestion information in an associated manner,
in said step a), said usage record information including said user ID information, said product ID information and further operation attribute information is received, and
in said step c), a retrieval is performed on said suggestion information storage part using a combination of operation attributes in a plurality of records of usage record information.

9. A method of offering product information from a manufacturer server to a shop server, said method comprising the steps of:
a) receiving usage record information including user identification (ID) information and product identification (ID) information;
b) storing said usage record information in a usage record information storage part;
c) retrieving suggestion information that matches the user record information associated with a product specified by said product ID information of a user specified by said user ID information stored in said usage record information storage part from a suggestion information storage part in which suggestion information is stored; and
d) sending said retrieved suggestion information and said user ID information to the shop server.

10. The method as claimed in claim 9, wherein said suggestion information storage part stores a combination of a plurality of records of operation attribute information and suggestion information in an associated manner,
in said step a), said usage record information including said user ID information, said product ID information and further operation attribute information is received, and
in said step c), a retrieval is performed on said suggestion information storage part using a combination of operation attributes in a plurality of records of usage record information.

11. A program for causing a computer to perform the steps of:
a) receiving usage record information including user identification (ID) information and product identification (ID) information;
b) storing and accumulating said usage record information in a usage record information storage part;
c) determining whether a product specified by said product ID information has been used for a period longer than a predetermined period of time by referring to said usage record information stored in said usage record information storage part which is associated with said product specified by said product ID information of a user specified by said user ID information;
d) retrieving sales promotion information associated with said product from a sales promotion information storage part in which sales promotion information is stored, when the result of said step c) is positive; and
e) sending said retrieved sales promotion information to the user server specified by said user ID information.

12. A program for causing a computer to perform the steps of:
a) receiving usage record information including user identification (ID) information and product identification (ID) information;
b) storing and accumulating said usage record information in a usage record information storage part;
c) determining whether a product specified by said product ID information has been used for a period longer than a predetermined period of time by referring to said usage record information stored in said usage record information storage part which is associated with said product specified by said product ID information of a user specified by said user ID information;
d) retrieving sales promotion information associated with said product from a sales promotion information storage part in which sales promotion information is stored, when the result of said step c) is positive; and
e) sending said retrieved sales promotion information and said user ID information to a shop server.

13. A program for causing a computer to perform the steps of:
a) receiving usage record information including user identification (ID) information and product identification (ID) information;
b) storing said usage record information in a usage record information storage part;
c) retrieving suggestion information that matches the user record information associated with a product specified by said product ID information of a user specified by said user ID information stored in said usage record information storage part from a suggestion information storage part in which suggestion information is stored; and
d) sending said retrieved suggestion information to a user server specified by said user ID information.

14. A program for causing a computer to perform the steps of:
a) receiving usage record information including user identification (ID) information and product identification (ID) information;
b) storing said usage record information in a usage record information storage part;
c) retrieving suggestion information that matches the user record information associated with a product specified by said product ID information of a user specified by said user ID information stored in said usage record information storage part from a suggestion information storage part in which suggestion information is stored; and
d) sending said retrieved suggestion information and said user ID information to a shop server.

15. A computer readable storage medium storing program code for causing a computer to offer information to a user server, comprising:
first program code means for receiving usage record information including user identification (ID) information and product identification (ID) information;
second program code means for storing and accumulating said usage record information in a usage record information storage part;
third program code means for determining whether a product specified by said product ID information has been used for a period longer than a predetermined period of time by referring to said usage record information stored in said usage record information storage part which is associated with said product specified by said product ID information of a user specified by said user ID information;
fourth program code means for retrieving sales promotion information associated with said product from a sales promotion information storage part in which sales promotion information is stored, when the result of said step c) is positive; and
fifth program code means for sending said retrieved sales promotion information to the user server specified by said user ID information.

16. A computer readable storage medium storing program code for causing a computer to offer information to a shop server, comprising:
first program code means for receiving usage record information including user identification (ID) information and product identification (ID) information;
second program code means for storing and accumulating said usage record information in a usage record information storage part;
third program code means for determining whether a product specified by said product ID information has been used for a period longer than a predetermined period of time by referring to said usage record information stored in said usage record information storage part which is associated with said product specified by said product ID information of a user specified by said user ID information;
fourth program code means for retrieving sales promotion information associated with said product from a sales promotion information storage part in which sales promotion information is stored, when the result of said step c) is positive; and
fifth program code means for sending said retrieved sales promotion information and said user ID information to the shop server.

17. A computer readable storage medium storing program code for causing a computer to offer information to a user server, comprising:
first program code means for receiving usage record information including user identification (ID) information and product identification (ID) information;
second program code means for storing said usage record information in a usage record information storage part;
third program code means for retrieving suggestion information that matches the user record information associated with a product specified by said product ID information of a user specified by said user ID information stored in said usage record information storage part from a suggestion information storage part in which suggestion information is stored; and
fourth program code means for sending said retrieved suggestion information to the user server specified by said user ID information.

18. A computer readable storage medium storing program code for causing a computer to offer information to a shop server, comprising:
first program code means for receiving usage record information including user identification (ID) information and product identification (ID) information;
second program code means for storing said usage record information in a usage record information storage part;
third program code means for retrieving suggestion information that matches the user record information associated with a product specified by said product ID information of a user specified by said user ID information stored in said usage record information storage part from a suggestion information storage part in which suggestion information is stored; and
fourth program code means for sending said retrieved suggestion information and said user ID information to the shop server.
